(19) United States
(12) Patent Application Publication
(10) Pub. No.: US 2009/0276367 A1
(43) Pub. Date: Nov. 5, 2009

(54) METHOD AND SYSTEM FOR PROVIDING RISK MANAGEMENT FOR MULTI-MARKET ELECTRONIC TRADING

(75) Inventor: Leslie ROSENTHAL, Chicago, IL (US)

Correspondence Address: LESAVICH HIGH-TECH LAW GROUP, P.C., SUITE 325, 39 S. LASALLE STREET, CHICAGO, IL, 60603, US

(73) Assignee: Rosenthal Collins Group, L.L.C., Chicago, IL (US)

(21) Appl. No.: 12/430,918

(22) Filed: Apr. 28, 2009

Related U.S. Application Data
(60) Provisional application No. 61/126,004, filed on Apr. 30, 2008.

(51) Int. Cl. G06Q 40/00

(52) U.S. Cl. 705/36 R

(57) ABSTRACT

A method and system for providing risk management for multi-market electronic trading. The method and system allow risk associated with one or more trading accounts for an electronic trader in multi-market electronic trading to be analyzed and managed in real-time. The method and system includes graphical display of risk assessments for plural traders. The risk assessment includes a set of risk parameters with current risk parameters and historical risk parameters and provides an integrated view of current and historical trading activities and trading resources of the electronic trader across all electronic trading exchanges the electronic trader is trading on (e.g. Chicago Board of Trade (CBOT), New York Stock Exchange (NYSE), NASDAQ, Tokyo Stock Exchange (TSE), London International Financial and Futures Options Exchange (LIFFE), etc.).

### CROSS REFERENCES TO RELATED APPLICATIONS

This U.S. Utility patent application claims priority to U.S. Provisional patent application 61/126,004, filed Apr. 30, 2008, the contents of which are incorporated by reference.

### FIELD OF THE INVENTION

This invention relates to risk management for electronic trading. More specifically, it relates to a method and system for providing risk management for multi-market electronic trading.

### BACKGROUND OF THE INVENTION

The trading of stocks, bonds and other financial instruments over computer networks such as the Internet has become a very common activity. In many countries of the world, such stocks, bonds and other financial instruments are traded exclusively over computer networks, completely replacing prior trading systems such as “open outcry” trading in trading pits.

Trading of stocks, bonds, etc. typically requires multiple types of associated electronic information. For example, to trade stocks electronically an electronic trader typically would like to know an asking price for a stock, a current bid price for a stock, a bid quantity, an asking quantity, current information about the company the trader is trading such as profit/loss information, a current corporate forecast, current corporate earnings, etc.

For an electronic trader to be successful, the multiple types of associated electronic information have to be supplied in real-time to allow the electronic trader to make the appropriate decisions. Such electronic information is typically displayed in multiple windows on a display screen.

In addition, when an electronic trader executes an electronic trade over a computer network, the computer network must respond to the order request in real-time in an appropriate, accurate, consistent manner. However, such electronic trade data is typically sent and received in a same data stream that supplies the multiple types of electronic information.

There are however a number of problems with electronic trading. One problem is risk assessment and risk management for electronic trading for multi-market electronic trading since traders have the capacity to lose large amounts of money when poor trading decisions are made or market conditions change in unexpected ways.

Thus, it is desirable to solve some of the problems associated risk assessment and risk management for electronic trading.

### SUMMARY OF THE INVENTION

In accordance with preferred embodiments of the present invention, some of the problems associated risk assessment and risk management for electronic trading are overcome. A method and system for providing risk management for multi-market electronic trading is presented.

The method and system allow risk associated with one or more trading accounts for an electronic trader in multi-market electronic trading to be analyzed and managed in real-time. The method and system includes graphical display of risk assessments for plural traders. The risk assessment includes a set of risk parameters with current risk parameters and historical risk parameters and provides an integrated view of current and historical trading activities and trading resources of the electronic trader across all electronic trading exchanges the electronic trader is trading on.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electronic trading system;

FIG. 2 is a flow diagram illustrating a method for proving electronic trading information;

FIG. 3 is a block diagram illustrating a data flow for the method of FIG. 2;

FIG. 4 is flow diagram illustrating a method for processing electronic trading information;

FIG. 5 is a block diagram illustrating a data flow for the method of FIG. 4;

FIG. 6 is a flow diagram illustrating a method for displaying electronic trading information from plural data streams;

FIG. 7 is a flow diagram illustrating a method for analyzing risk for electronic trading;

FIG. 8 is a flow diagram illustrating a method for analyzing risk for electronic trading;

FIG. 9 is a block diagram illustrating graphical display of risk assessment for electronic trading; and

FIG. 10 is flow diagram illustrating a method for automatically and dynamically determining a risk threshold.

### DETAILED DESCRIPTION OF THE INVENTION

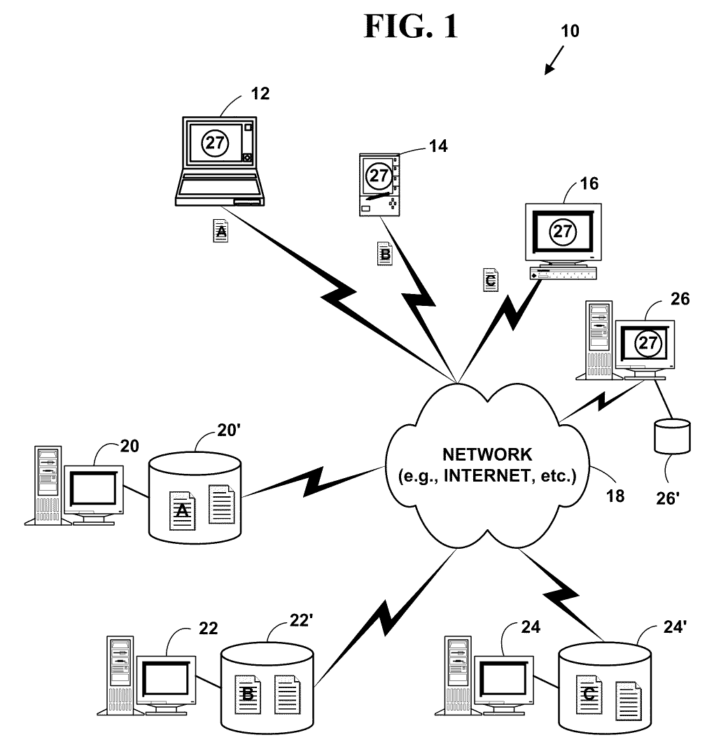

FIG. 1 is a block diagram illustrating an exemplary electronic trading system 10. The exemplary electronic information updating system 10 includes, but is not limited to, one or more target network devices 12, 14, 16 (only three of which are illustrated). However, the present invention is not limited to these target electronic devices and more, fewer or others types of target electronic devices can also be used.

The target devices 12, 14, 16 are in communications with a communications network 18. The communications includes, but is not limited to, communications over a wire connected to the target network devices, wireless communications, and other types of communications using one or more communications and/or networking protocols.

Plural server network devices 20, 22, 24 (only three of which are illustrated) include one or more associated databases 20′, 22′, 24′. The plural network devices 20, 22, 24 are in communications with the one or more target devices 12, 14, 16 via the communications network 18. The plural server devices 20, 22, 24, include, but are not limited to, World Wide Web servers, Internet servers, file servers, other types of electronic information servers, and other types of server network devices (e.g., edge servers, firewalls, routers, gateways, etc.).

The plural server devices 20, 22, 24 include, but are not limited to, servers used for electronic trading exchanges, servers for electronic trading brokers, servers for electronic trading information providers, etc.

The one or more target network devices 12, 14, 16 may be replaced with other types of devices including, but not limited to, client terminals in communications with one or more servers, or with personal digital/data assistants (PDA), laptop computers, mobile computers, Internet appliances, two-way pagers, mobile phones, or other similar desktop, mobile or hand-held electronic devices. Other or equivalent devices can also be used to practice the invention.

In one embodiment, a risk application 27 presents provides risk management via the methods and system described herein and/or provides graphical and non-graphical risk management information on graphical user interface (GUI) on a display on the network devices. The GUI presents a multi-window interface to an electronic trader. In one embodiment, the risk application 27 is included only on server network devices 26. In another embodiment, the risk application 27 is included on all network devices including target network devices 12, 14, 16. However, the invention can be practiced without including the risk application 27 on any target network devices 12, 14, 16.

In one embodiment of the invention, the risk application 27 is a software application. However, the present invention is not limited to this embodiment and the risk application 27 can also be firmware, hardware or a combination thereof.

The communications network 18 includes, but is not limited to, the Internet, an intranet, a wired Local Area Network (LAN), a wireless LAN (WiLAN), a Wide Area Network (WAN), a Metropolitan Area Network (MAN), a Public Switched Telephone Network (PSTN) and other types of communications networks 18.

The communications network 18 may include one or more gateways, routers, or bridges. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another.

The communications network 18 may include one or more servers and one or more web-sites accessible by users to send and receive information usable by the one or more computers 12. The one ore more servers, may also include one or more associated databases for storing electronic information.

The communications network 18 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is known in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 18 and the present invention is not limited to TCP/UDP/IP.

An operating environment for the devices of the exemplary electronic trading system 10 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals by the CPU or processor. An electrical system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Processing Electronic Trading Information

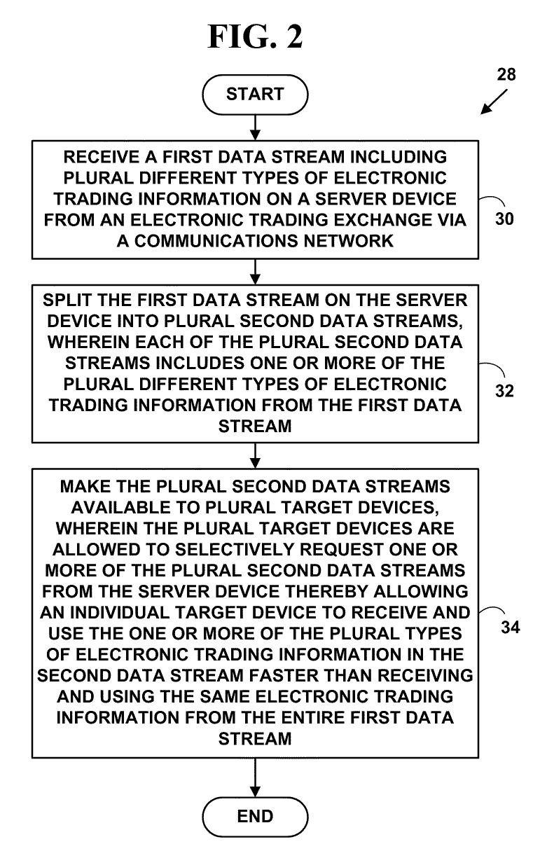

FIG. 2 is a flow diagram illustrating a Method 28 for processing electronic trading information. At Step 30, a first data stream is received on a server device including plural different types of electronic trading information from an electronic trading exchange via a communications network. At Step 32, the first data stream on the server device is split into a plural second data streams. Each of the plural second data streams includes one or more of the plural different types of electronic trading information from the first data stream. At Step 34, the plural second data streams are made available to plural target devices via the server device. The plural target devices are allowed to selectively request one or more of the plural second data streams from the server device thereby allowing an individual target device to receive and use the one or more of the plural types of electronic trading information in the second data stream faster than receiving and using the same electronic trading information from the first data stream.

Method 28 is illustrated with an exemplary embodiment. However, the invention is not limited to this embodiment and other embodiments can also be used to practice the invention.

In such an exemplary embodiment at Step 30, a first data stream including plural types of electronic information related to electronic trading is received on a server device 26 from one or more electronic trading exchanges 20, 22, 24 via a communications network 18. In one embodiment of the invention the first data stream includes, but is not limited to, electronic trading information from an electronic trading exchange (e.g., New York Stock Exchange, Chicago Board of Trade, Chicago Mercantile Exchange, London Stock Exchange, Tokyo Stock Exchange, etc.).

The multi-markets include, but are not limited to, trading of stocks, bonds, commodities, financial instruments, cash currencies, options, spreads, etc. and include electronic trading of plural items at multiple locations simultaneously. The instruments and/or contracts may be real (i.e., actually exist) or synthetic. The trading may also include yield curve trading, black box trading and differential trading across multiple markets.

As is known in the art, a “synthetic” instrument or contract includes an instrument or contract that does not really exist on any electronic trading exchange. A synthetic can be made up of one, or several actual contracts that trade on an exchange or multiple exchanges. For example, a synthetic contract may include automatically selling a call and buying a put for two actual futures contracts. Such a synthetic contract does not exist on any trading exchange but is desirable to a selected group of traders.

As is known in the electronic trading arts, a “yield curve” is a chart in which a yield level is plotted on one axis (e.g., a vertical axis, etc.), and the term to maturity of debt instruments or other similar instruments are plotted on another axis (e.g., a horizontal axis, etc.). In general, when yields are falling, a yield curve will steepen. When yields are rising, a yield curve will flatten.

In finance, a yield curve is a relationship between treasury securities that are traded for a given maturity and a spread that is derived between them. The yield of a debt instrument is the return an investor should expect at that price by investing in that instrument and is its coupon. Investing for a period of time t gives a yield Y(t). This function Y is called the “yield curve.” The nomenclature “curve” is used rather than “yield function” because when plotted on a graph, the function is a curve.

Yield curves are used by commodity and other financial instrument traders to seek trading opportunities. For commodities trading, market participants often sell short and buy long, or sell long positions and buy short positions using yield curves and use trading spreads to determine trading opportunities. However, the present invention is not limited to these trading strategies for commodities and other trading strategies can also be used.

In one embodiment, yield curve electronic trading strategies are used with the electronic trading system 10 described above. Yield curve trading permits electronic traders to price any commodity contract, financial instrument or security instrument off of any other security commodity contract, financial instrument or security instrument with a yield curve using a price, yield, basis spread or other spreads. The yield curve electronic trading strategies include electronic trading via multiple yield curves by asset class, curves-off-curve, curves-on-curve, one or two standard deviations or yield curve results, etc.

In one embodiment, yield curve electronic trading strategies include, real trading strategies, synthetic trading strategies, spread trading strategies, black box trading strategies and supply differential trading strategies, or any combination thereof.

As is known in the art, a “futures spread” includes a purchase of one futures delivery month contract against the sale of another futures delivery month contract of the same commodity; the purchase of one delivery month contract of one commodity against the sale of that same delivery month contract of a different commodity; or the purchase of one commodity contract in one market against the sale of the commodity contract in another market, to take advantage of a profit from a change in price relationships. The term spread is also used to refer to the difference between the price of a futures month contract and the price of another month contract of the same commodity or the yield difference between the securities.

An “intra-commodity” spread (e.g., a calendar spread) is long at least one futures contract and short at least one other futures contract. Both have the same underlying futures contract but they have different maturities.

An “inter-commodity” spread is a long-short position in futures contracts on different underlying futures contracts. Both typically have the same maturity. Spreads can also be constructed with futures contracts traded on different exchanges. Typically this is done using futures on the same underlying contract, either to earn arbitrage profits or, in the case of commodity or energy underlying contracts, to create an exposure to price spreads between two geographically separate delivery points.

A “different commodities spread” is a spread between two or more different commodities contracts of any type of any maturity and any type of position. (e.g., (Mini S&P)/(Mini NSDAQ), or (Mini S&P)/(Mini DJ), etc.).

A “crack spread” is a commodity contract—commodity product contract spread involving the purchase of a commodity and the sale of a product. For example, the purchase of crude oil futures contracts and the sale of gasoline and/or heating oil futures contracts.

Spread trading offers reduced risk compared to trading futures contracts outright. Long and short futures contracts comprise a spread that correlated, so they tend to hedge one another. For this reason, exchanges generally have less strict margin requirements for future contract spreads.

A “butterfly spread” for futures contracts includes a spread trade in which multiple futures contract months are traded simultaneously at a differential. The trade basically consists of two or futures spread transactions with either three or four different futures months at one or more differentials.

Spread trading is also used for options. An option spread trade is when a call option is bought at one strike price and another call option is sold against a position at a higher strike price. This is a called a “bull spread.” A “bear spread” includes buying a put option at one strike price and selling another put option at a lower strike price.

A “butterfly spread” for options includes selling two or more calls and buying two or more calls on the same or different markets and several expiration dates. One of the call options has a higher strike price and the other has a lower strike price than the other two call options. If the underlying stock price remains stable, the trader profits from the premium income collected on the options that are written.

A “vertical spread” for options includes a simultaneous purchase and sale of options of the same class and expiration date but different strike prices. A vertical spread for futures contracts includes a simultaneous purchase and sale of futures contracts with the same expiration date but different prices.

A “horizontal spread” includes the purchase and sale of put options and call options having the same strike price but different expiration dates. A horizontal spread for futures contracts includes the purchase and sale of futures for the same purchase price but different expiration dates.

A “ratio spread” applies to both puts and calls, involves buying or selling options at one strike price in greater number than those bought or sold at another strike price. “Back spreads” and “front spreads” are types of ratio spreads.

A “back spread” is a spread which more options are bought than sold. A back spread will be profitable if volatility in the market increases. A “front spread” is a spread in which more options are sold than bought. A front spread will increase in value if volatility in the market decreases.

The purpose of an option spread trade is two-fold. First, it bets on the direction that a trader thinks a certain stock will go. And second, it reduces a trader's cost of the trade to the difference between what is paid for the option and what profit is obtained from selling the second option. An option profit is the spread, or the difference between the two strike prices, minus a cost of the spread.

An “inter-exchange” spread is a difference in a price of same security, instrument or contract traded on different exchanges. For examples, the price of a stock for a computer of brand-X on the New York Stork Exchange and the Tokyo Stock exchanges.

Various types of spreads (e.g., vertical, horizontal, ratio, back, front, etc.) are also used to trade futures contracts, stocks, bonds and other financial instruments and financial contracts in addition to options.

A “black box” trading strategy includes, but is not limited to, trading strategies developed by one or more traders for futures contracts, options contracts, or other instruments for differed shipment or delivery or otherwise, or other contracts or financial or other instruments traded electronically. The black box trading entity may be created only for sell-side trades, only for buy-sides trades, both buy and sell trades, spreads, and other types of real or synthetic trades that can be executed electronically.

“Supply differentials” are identified by monitoring variance in relative trade volume, block trade transactions, and a corresponding movement in net change. Real trade volume and exchange time and sales provide a data source. In one example, a trader will execute a buy trade in an instrument with a greatest relative increase in buy volume from a previous time period and fade the instrument with the smallest increase in relative volume.

In one embodiment the server device 26 includes a server device for an electronic trading broker. However, the present invention is not limited to such an embodiment.

The first data stream includes, but is not limited to, plural types of electronic information including, but not limited to, current market data, posting and canceling of order information, order fill and status information, commentary by market analysts, current market news and other types of information relevant to electronic trading sent from the electronic trading exchange.

This first data stream is provided in many different formats. One format includes a data stream with one portion of information for each data category included in the first data stream in each data packet sent across the communications network 18. Another format includes interleaving data packets in the data stream wherein each data packet includes only one type of electronic trading information. For example, a first data packet in the data stream may include only current price information for a specific financial instrument. A second data packet in the data stream may include only order fill and status information, etc. These and other formats may be used by the trading exchanges 20, 22, 24 to send out data streams.

All formats used by the electronic trading exchanges 20, 22, 24 are complex data streams that require a large number of cycles on a CPU or other processor included on a target device 12, 14, 16. Such a complex data stream therefore is very slow to receive, process, display and/or other use on the target device 12, 14, 16. The server device 26 accepts these and other complex data stream formats and splits the electronic trading information contained therein into the plural second data streams that are more manageable, easier and more effect to receive, use and display on the target devices 12, 14, 16.

At Step 32, the first data stream on the server device 26 is split into a plural second data streams. Each of the plural second data streams includes one or more of the plural different types of electronic trading information from the first data stream. For example, the first data stream including current market data, posting and canceling of order information, order fill and status information is split into plural separate data streams with one of the plural second data streams including only current market data, another one of the plural second data streams including only posting and canceling of order information, yet another one of the plural second data streams including only order fill and status information, etc.

At Step 34, the plural second data streams are made available to the plural target device 12, 14, 16 via the server device 26. The plural target devices 12, 14, 16 are allowed to selectively request one or more of the plural second data streams from the server device 26 thereby allowing an individual target device 12, 14, 16 to receive and use the one or more of the plural types of electronic trading information in the second data stream faster and more efficiently than receiving and using the same electronic trading information from the entire first data stream.

For example, a target device 12 may request one of the plural data streams relating only to current market data, while another target device 14 may request two plural data streams relating to posting and canceling of order information and order fill and status information, etc. Since a target device 12, 14, 16 can select only the individual data streams from plural second data streams that are desired, the target device 12, 14, 16 is able to receive and use the selected data streams from the plural data steams instead of receiving and processing the entire first data stream including all of the plural types of electronic trading information.

Using selected ones of the plural second data streams requires a smaller bandwidth to send the data stream over the communications network 18 to the target devices 12, 14, 16. Using selected ones of the plural second data streams also requires less processing cycles for a processor or CPU on a target device 12, 14, 16. Therefore, a user of target device 12, 14, 16 can make electronic trading decisions quicker.

In one embodiment, the one server device 26 is specifically configured for and optimized for receiving the first data stream 38, for splitting the first data stream 38 into the plurality of second data streams 44, 46, 48 and receiving requests from the plurality of target devices 12, 14, 16 and selectively sending the requested information to the plurality of target devices 12, 14, 16.

In other embodiments, plural server devices can be used instead of the one server device 26. In such other embodiments each of the plural server devices are specifically configured for and optimized executing one, or more than one, of the steps of Method 28.

Method 28 is illustrated with processing one first data stream from one trading exchange. However, the present invention is not limited to such an embodiment and Method 28 can also be used to split plural first data streams into plural sets of plural second data streams.

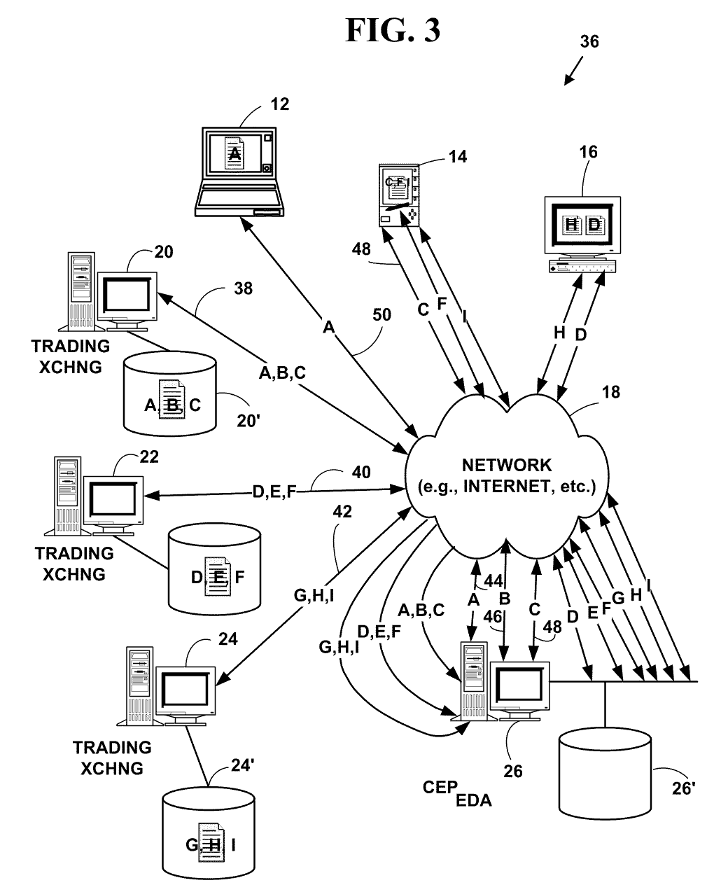

FIG. 3 is a block diagram illustrating a data flow 36 for Method 28. At Step 30, a first data stream 38 is received on a server device 26 including plural different types of electronic trading information A, B, C from an electronic trading exchange 20 via a communications network 18. At Step 32, the first data stream 38 is split into plural second data streams 44, 46, 48 on the server device 26. Each of the plural second data streams 44, 46, 48 includes one or more of the plural types of electronic trading information from the first data stream. At Step 34, the plural second data streams 44, 46, 48 are made available via the server device 26 to plural target devices 12, 14, 16. The plural target devices 12, 14, 16 are allowed to selectively request one or more of the plural second data streams 44, 46, 48 from the server device 26 thereby allowing an individual target device 12, 14, 16 to receive and use the one or more of the plural types of electronic trading information in the second data streams 44, 46, 48 faster than receiving and using the same electronic trading information from the first data stream 38. For example, target device 12 may request only one individual data stream 50 from the server device 26 that corresponds to data stream A 44 from the electronic trading exchange server 20. Similarly target device 14 may request, three data streams C, F and I from three different trading exchanges 20, 22, 24 and target device 16 may request only two data streams C and H from trading exchange 22 and 24.

In FIG. 3, the exemplary electronic trading exchanges are illustrated as providing only three different types of electronic trading information in a data stream for simplicity. An actual first data stream from the electronic trading exchanges 20, 24, 26 typically includes many more than three different type of electronic trading information.

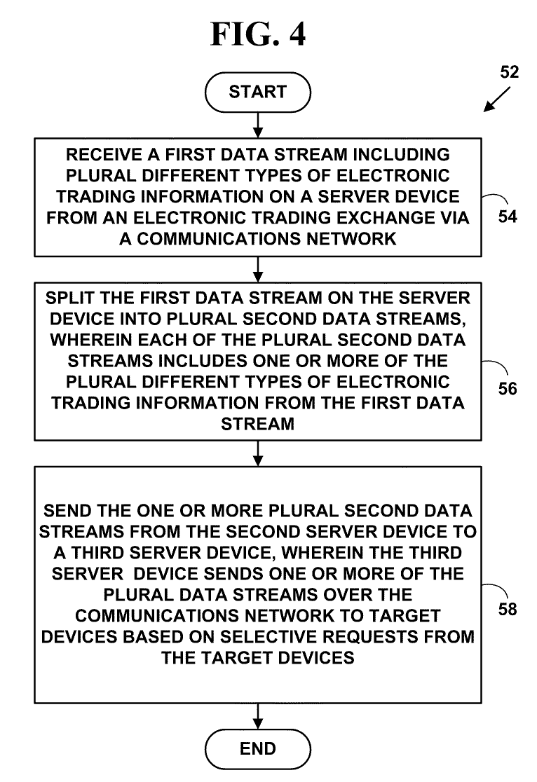

FIG. 4 is flow diagram illustrating a Method 52 for processing electronic trading information. At Step 54, a first data stream including plural types of electronic information related to electronic trading is received on a first server device from an electronic trading exchange via a communications network. At Step 56, the data stream is sent to a second server device and split into plural second data streams where each of the plural second data streams includes one or more of the plural types of electronic information from the first data stream. At Step 58, one or more of the plural second data streams are sent from the second server device to a third server device. The third server device sends one or more of the plural data streams over the communications network to target devices based on selective requests from the target devices.

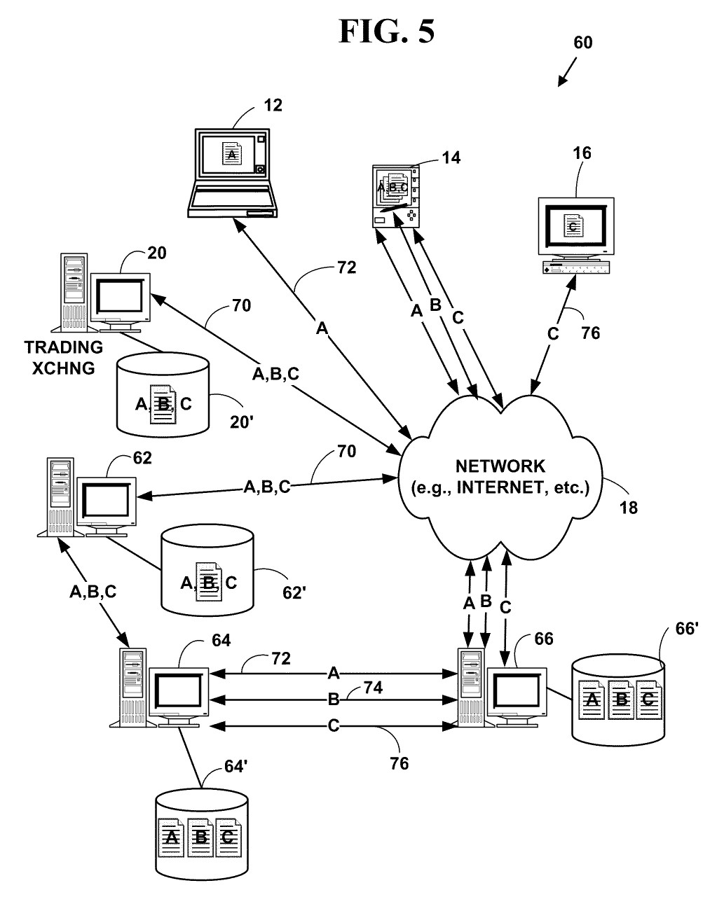

FIG. 5 is a block diagram illustrating a data flow 60 for Method 52. Data flow 60 illustrates one electronic trading exchange 20 and three servers 62, 64, 66.

Method 52 is illustrated with an exemplary embodiment. However, the invention is not limited to this embodiment and other embodiments can also be used to practice the invention.

In such an exemplary embodiment at Step 54, a first data stream 70 including plural types of electronic information related to electronic trading is received on a first server device 62 from an electronic trading exchange 20 via a communications network 18. The first server device 62 is specifically configure for and optimized for receiving the first data stream 70 from the communications network 18.

At Step 56, the first data stream 70 is sent to a second server device 64 and split into plural second data streams 72, 74, 76 where each of the plural second data streams includes one or more of the plural types of electronic information from the first data stream 70. The second server device 64 is specifically configured for and optimized for splitting the first data stream 70.

At Step 58, one or more of the plural second data streams 72, 74, 76 are sent from the second server device 64 to a third server device 66. The third server device 66 makes the plural second data streams 72, 74, 76 available to the plural target devices 12, 14, 16 and sends one or more of the plural data streams 72, 74, 76 over the communications network 18 to a target device 12, 14, 16 based on selective requests from the target device. The third server device 66 is specifically configured for and optimized for receiving requests from the target devices 12, 14, 16 and selectively sending the requested information to the target devices 12, 14, 16 via the communications network 18.

Method 52 is illustrated with three server devices. However, Method 52 can be practiced with more or fewer server devices and the present invention is not limited to three server devices. Method 52 is also illustrated with one communications network 18. Method 52 can also be practiced with more than one communications network including both public and private communications network portions.

Method 52 also allows target devices 12, 14, 16 to selectively receive one or more of the plural second data streams based on selective requests. Thus, the information in the one or more plural data streams is received faster and is more easily and efficiently adapted to a user's preferences (e.g., an electronic trader) using the target devices 12, 14, 16. Method 52 also allows for quicker sending and receiving of electronic trading orders as they are placed and filled.

Displaying Electronic Trading Information from Plural Data Streams

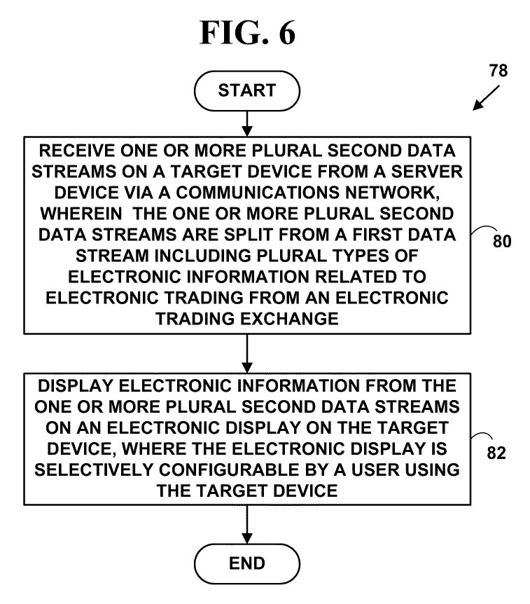

FIG. 6 is a flow diagram illustrating a Method 78 for displaying electronic trading information from plural data streams. At Step 80, one or more plural second data streams are received on a target device from a server device via a communications network. The one or more plural second data streams were split from a first data stream including plural types of electronic information related to electronic trading from an electronic trading exchange. At Step 82, electronic information from the one or more plural second data streams are displayed on an electronic display on the target device. The electronic display is selectively configurable by a user using the target device based on selected ones of the plural second data streams selected by a user.

Method 78 is illustrated with an exemplary embodiment. However, the invention is not limited to this embodiment and other embodiments can also be used to practice the invention.

In such an exemplary embodiment at Step 80, one or more plural second data streams 44, 46, 48 are received on a target device 12, 14, 16 from a server device 26 via a communications network 18. The one or more plural second data streams 44, 46, 48 were split from a first data stream 38 including plural types of electronic information related to electronic trading from an electronic trading exchange 20.

At Step 82, electronic information from the one or more plural second data streams 44, 46, 48 are displayed on an electronic display on the target device 12, 14, 16. The electronic display is selectively configurable by a user using the target device based on selected ones of the plural second data streams selected by a user. For example, a user may configure a window-X for one of the selected plural second data streams, a window-Y for another one of the selected plural second data streams 44, 46, 48, etc. where each window, X, Y, etc. includes specific characteristics configured by the user (e.g., size, shape, color, etc.).

In one embodiment of the present invention, the plural second data streams 40, 42, 44 are displayed in multiple windows on the electronic display. The multiple windows, include, but are not limited to, a positions window, a market watcher window, a trade window and other types of windows displaying information relevant to electronic trading using information from the plural second data streams 44, 46, 48.

Table 1 illustrated an exemplary positions window that is displayed on the electronic display of a target device 12, 14, 16 using one of the plural second data streams 44 related to market positions.

TABLE 1

| Issue | Position | P&L | Price | Commission |
|---|---|---|---|---|
| usg 10Y | 1 | 225 | 111-14 | 54 |
| 10Y Dec03 FT | 100 | 288 | 113-18 | 24 |
| Total | | 513 | | 78 |

Table 2 illustrates an exemplary market watcher window that displays cash and futures pricing information using another one of the plural second data streams 46 related to cash and futures pricing.

TABLE 2

| Issue | BidPrice | BidQty | AskPrice | AskQty |
|---|---|---|---|---|
| usg 10Y | 111-145 | 5 | 111-14 | 42 |
| 10Y Dec03 FT | 113-19 | 60 | 113-18 | 32 |

Table 3 illustrates an exemplary trade window that displays information about a current day's trades using another one of the plural second data streams 48 related to cash and futures pricing.

TABLE 3

| Desc. | Price | Quan. | Side | Time | Facility | Type | TradeID | Price32 |
|---|---|---|---|---|---|---|---|---|
| usg 10Y | 100.4838 | 1 | Sell | 7:05:33 | A | Cash | SA43217 | 100-15.5 |
| usg 10Y | 100.4838 | 1 | Sell | 11:04.18 | A | Cash | SA43217 | 100-15.5 |
| usg 10Y | 10.4537 | 1 | Sell | 11:10:15 | A | Cash | BA43217 | 100-14.5 |
| 10Y | 113.5313 | 1 | Sell | 17:10:43 | A/C/E | Future | 2858590 | 113-17 |
| DEC 03 | | | | | | | | |
| FT | | | | | | | | |
| 10Y | 113.5313 | 1 | Sell | 17:11:29 | A/C/E | Future | 28585090 | 113-17 |
| Dec03 | | | | | | | | |
| FT | | | | | | | | |
| 10Y | 113.5625 | 1 | Sell | 13:05:58 | A/C/E | Future | 28522090 | 113-18 |
| Dec03 | | | | | | | | |
| FT | | | | | | | | |

The information illustrated in Tables 1-3 are exemplary only. Other types of electronic information in other formats can also be used and the invention is not limited to the electronic information displayed that is obtained from the plural second data streams 44, 46, 48.

Methods 28, 52 and 78 can be used to provide real-time notification and display of electronic cash and futures trades, real-time calculation of profit and loss (P&L) marked to market, including commissions, real-time calculation of positions, ability for a trader to manually enter and edit voice trades or possible trades, to alter P&L positions and simple viewing, searching and printing of day trades.

The electronic information from the plural second data stream can also be dumped into and displayed directly from electronic spreadsheets such as Mircosoft Excel and other electronic spreadsheets.

In another embodiment of the invention, an interface (e.g., a web-page) is provided on a server device 26 on the communications network 18 allows a user to login and view electronic trading information related to their own electronic trading activities. The electronic information is obtained from the plural second data streams 44, 46, 48.

### Providing Risk Management Assessment for Electronic Trading

“Risk management” is the discipline of identifying, monitoring and limiting risks. Risk management methodologies typically consist of a number of analysis steps, including but not limited to, identifying critical assets, identifying, characterizing, and assessing threats to the identified assets, assessing the vulnerability of critical assets, identifying ways to reduce vulnerability of critical assets, creating a risk management strategy and prioritizing risk reduction measures.

The risk management strategies include, but are not limited to, transferring the risk to another party, avoiding the risk, reducing the negative effect of the risk, and accepting some or all of the consequences of an existing risk. In ideal risk management, a prioritization process is followed whereby the risks with the greatest loss and the greatest probability of occurring are handled first, and risks with lower probability of occurrence and lower loss are handled in descending order.

Once risks have been identified and assessed, techniques to manage the risk typically fall into one or more major categories including, but not limited to, risk avoidance, risk reduction, risk transfer and/or risk retention.

Risk management is used for electronic trading to identify and mitigate risks associated with electronic trading. Risk management is analyzed at plural levels, including but not limited to, a trader, broker, trading firm, fund manager, trading exchange level, etc.

For example, trading of commodities futures contracts is a zero sum transaction wherein there is a winner and a loser for every trade and trades are reconciled daily. An electronic trader typically opens a trading account (also called a “margin account ”) with a certain minimum amount of trading capital with one or more brokers who provide the ability for the electronic trader to execute electronic trades on one or more trading exchanges.

A “margin ” is collateral that the holder of a trading position (e.g., electronic trader, etc.) in securities, options, or futures contracts has to deposit to cover the credit risk of his/her broker. This risk can arise if the electronic trader has borrowed cash from the broker to buy securities or options, sold securities or options short, or entered into a futures contract, etc. Risk management typically includes evaluating not only electronic trading activities, but also margin values for one or more margin accounts held by the electronic trader.

If an electronic trader is trading a commodity contract, and has bought the contract expecting the price of the commodity to rise, the trader may lose money if the price of the commodity declines. Theoretically, the trader's risk of loss is limited only by the price of the commodity going to zero, the point at which the trader has lost all of his/her money.

If a trader sells a commodity contract short expecting the price of the commodity to decline, the trader will lose money if the price of the commodity goes up. The risk of loss is theoretically unlimited because there is no absolute ceiling on how high the price of the commodity can go.

Risk management is important not only for an electronic trader, but for brokers, trading firms, fund managers, trading exchanges and other entities involved in electronic trading and other types of electronic and non-electronic (e.g., open outcry, etc.) trading.

A “commodity broker” is a firm or individual who executes orders to buy or sell commodity contracts on behalf of clients and charges them a commission. A firm or individual who trades for his/her own account electronically via a commodity broker (or other broker) is called an “electronic trader.” Commodity contracts include futures, options, and similar financial derivatives. Clients who trade commodity contracts are either hedgers using the derivatives markets to manage risk, or speculators who are willing to assume that risk from hedgers in hopes of a profit.

Other types of brokers include Futures Commission Merchants (FCMs), Independent Introducing Brokers (IIBs), Guaranteed Introducing Brokers (GIBs), Foreign Introducing Brokers (FIBs), Commodity Trading Advisors (CTAs), Commodity Pool Operators (CPOs) Broker-Dealers (B/Ds) and other types of brokers.

The present invention presents a solution to manage risk for electronic trading and for non-electronic trading. One of the benefits of this solution is the ability to capture information about a trade independent of the source of execution of the trade. The trade execution could be electronic execution by the electronic trader, a broker executed trade, an open outcry trading floor based trade or a walk-in trade.

The present invention also provides risk management by looking at a trader via an “integrated viewpoint.” The present invention is unique and provides unexpected results because the present invention aggregates a trader's activities across all their trading accounts, their current and historical trades and trade locations on all trading exchanges (e.g., Chicago Board of Trade (CBOT), New York Stock Exchange (NYSE), NASDAQ, Tokyo Stock Exchange (TSE), London International Financial and Futures Options Exchange (LIFFE), etc.) and values of all their margin capital accounts.

### Analyzing Risk for Electronic Trading

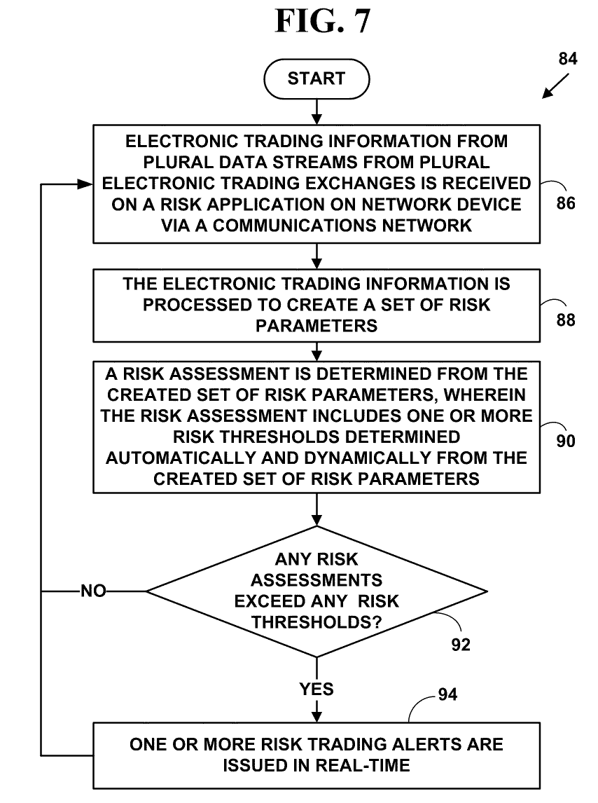

FIG. 7 is a flow diagram illustrating a Method 84 for analyzing risk for electronic trading. At Step 86, electronic trading information for an electronic trader is collected periodically in real-time via a communications network via a risk application executing in a memory on a network device. The collected electronic trading information includes current and historical electronic trading execution information and current market trading information from plural data streams from plural electronic trading exchanges, one or more trading accounts being used by the electronic trader. The one or more trading accounts including current trading positions and current available trading capital in the one or more trading accounts. At Step 88, the electronic trading information is processed with a pre-determined method to create a set of risk parameters. The set of risk parameters include current risk parameters and historical risk parameters and provide an integrated view of current and historical trading activities and trading resources of the electronic trader across all electronic trading exchanges the electronic trader is trading on (e.g., Chicago Board of Trade (CBOT), New York Stock Exchange (NYSE), NASDAQ, Tokyo Stock Exchange (TSE), London International Financial and Futures Options Exchange (LIFFE), etc.). At Step 90, a risk assessment is determined from the created set of risk parameters. The risk assessment includes one or more risk thresholds determined automatically and dynamically from the created set of risk parameters. At Step 92, a test is conducted to determine if the risk assessment exceeds one or more of the determined risk thresholds. If the determined risk exceeds one or more of the determined risk thresholds, one or more trading alerts are issued in real-time at Step 94. The one or more real-time trading alerts are used to notify a trader, one or more brokers servicing the electronic parties and other designated parties that a trader has currently exceeded one or more of the determined risk thresholds.

Method 84 is illustrated with one exemplary embodiment. However, the present invention is not limited to this embodiment and other embodiments can also be used to practice the invention.

In such an exemplary embodiment at Step 86, electronic trading information for an electronic trader is automatically and periodically collected in real-time via a communications network 18 via a risk application 27 executing in a memory on a server network device 26. In another embodiment, the risk application 27 is executing on the target network devices 12, 14, 16. In another embodiment, the risk application 27 is executing on both the server network device 26 and the target network devices 12, 14, 16.

The collected electronic trading information includes current and historical electronic trading execution information and current market trading information from plural data streams 38-48 from plural electronic trading exchanges 20, 22, 24, one or more trading accounts being used by the electronic trader. The one or more trading accounts including current trading positions, profits and loss and current available trading capital in the one or more trading accounts including margin accounts.

In one embodiment, the one or more trading accounts including trading accounts at one or more brokers. For example, the electronic trader may have a trading account with one or more brokers such Rosenthal Collins Group, LLC, Cantor Fitzgerald, E-trade, etc. Electronic trading information is automatically, collected for all trading accounts being used by the electronic trader.

In such an embodiment, electronic trading information from plural data streams 38, 40, 42, 44, 46, 48 from plural electronic trading exchanges 20, 22, 24 is received via a communications network 18 on a target device 12, 14, 16.

In one embodiment, the plural data streams include original real-time data streams 38, 40, 42 and/or historical data streams from the electronic trading exchanges. In another embodiment, the plural data streams include the plural second data streams 44, 46, 48 that were processed by server 26 as was described above with Methods 28, 52 and/or 78. As was discussed above methods 28, 52 and 78 can be used to provide real-time notification and display of electronic stock, bond, cash, financials, options and commodity futures trades, real-time calculation of profit and loss (P&L) marked to market, including commissions, real-time calculation of current positions in multi-level markets. This information is provided for more real and synthetic trades trading spreads and yield curves.

In one embodiment, the processed electronic trading information is used in part for risk assessment. In such an embodiment, the Methods 28, 52 and/or 78 described are used to increase the speed at which electronic trading information is available for desired uses. However, the present invention is not limited to the processing Methods 28, 52 and/or 78 and other methods can also be used to practice the invention.

At Step 88, the electronic trading information is processed with a pre-determined method to create a set of risk parameters. The set of risk parameters include current risk parameters and historical risk parameters and provide an integrated view of current and historical trading activities and trading resources of the electronic trader.

In one embodiment, the set of risk parameters include, but are not limited to, maximum absolute position value by all accounts on all trading exchanges, absolute net position change by all accounts on all trading exchanges, total change in all positions in all accounts in all trading exchanges, total account value decline of greater than a pre-determined threshold (e.g., greater than 20%, etc.), total trade volume and net profit and loss.

In one embodiment, the pre-determined method, includes, but is not limited to, producing real-time statistical studies of the collected electronic trading information including real-time statistical studies of historical electronic trading information and real-time statistical studies of current electronic trading information.

At Step 90, a risk assessment is determined from the created set of risk parameters. The risk assessment includes, but is not limited to, total account values, prior historical trading histories, current trading histories, etc. across all accounts with all brokers, etc. on all trading exchanges. The risk assessment includes one or more risk thresholds determined automatically and dynamically from the created set of risk parameters.

In one embodiment, Step 90 includes a Method 108 for dynamically and automatically determining and setting threshold values for alerts in real-time.

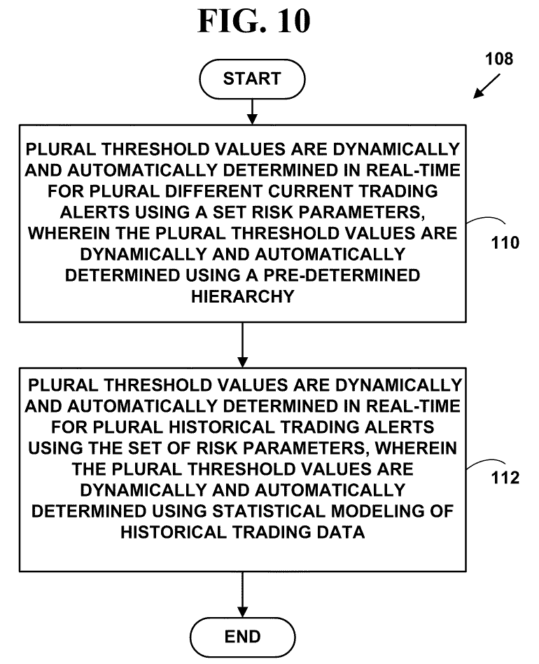

FIG. 10 is flow diagram illustrating a Method 108 for automatically and dynamically determining a risk threshold. A step 110, plural threshold values are dynamically and automatically determined in real-time for plural different current trading alerts using a set risk parameters. The plural threshold values are dynamically and automatically determined using a pre-determined hierarchy. At Step 112, plural threshold values are dynamically and automatically determined in real-time for plural historical trading alerts using the set of risk parameters. The plural threshold values are dynamically and automatically determined using statistical modeling of historical trading data.

In one embodiment of Method 108, threshold values for two types of trading alerts are determined. The trading alerts include two types of alerts: (1) current trading alerts; and (2) historical trading alerts. However, the present invention is not limited to this number or type of alerts and more fewer or other types of alerts can also be used to practice the invention.

The current trading alerts are based upon current trading activities by the electronic trader. The historical trading alerts are based upon historical trading activities of the electronic trader.

The current trading alerts and the historical alerts each have three levels of alerts: (1) notification; (2) warning; (3) emergency alerts. However, the present invention is not limited to this number or type of alerts and more fewer or other types of alerts can also be used to practice the invention.

In one embodiment, the notification alert would simply notify the electronic trader of an impending risk condition, the warning alert would notify the electronic trader risk parameters may be currently exceeded or will be exceeded shortly and the emergency alert would notify the electronic trader of an emergency condition in which risk parameters have been exceed and electronic trading is being suspended and/or terminated until the electronic trader takes some addition action (e.g., provides more capital to a margin account, removes one or more trading positions, etc.).

In one embodiment, for current trading alerts, the alert thresholds are automatically and dynamically determined based on dynamic or static risk management trading value amounts currently being used for a pre-determined hierarchy. In one embodiment, the pre-determined hierarchy is an account hierarchy that includes: (1) trading firm; (2) trading firm office (e.g., a trading firm may have plural offices at plural geographic locations, etc.); and (3) trading account. In another embodiment, the pre-determined hierarchy includes: (1) current trading positions; (2) historical trading activity; (3) trading account margins. However, the present invention is not limited to such an embodiment and other hierarchies with more, fewer or different components can also be used to practice the invention.

Current trading alerts are used to notify parties of risk based on current market conditions. This includes extreme risk trades, described as O'Hare trades below. However, the present invention is not limited to this method for determining threshold values for standard alerts, and other methods for this and other types of alerts can be used to practice the invention.

In one embodiment, for historical alerts, the alert threshold is based on a model of all of the electronic trader's accounts historical behavior. In one embodiment, the historical alert thresholds are calculated dynamically and automatically in real-time using statistical modeling in part using the formula illustrated in Equation (1). However, the present invention is not limited to this formula and other formulas can be used to practice the invention.

Maximum of ((X*average account daily trade volume)+(Y*(standard deviation of account daily trade volume)) or Base Value, (1)

where X and Y are trading values determined for the electronic trader.

Historical trading information is used for evaluating risk for an electronic trader as in certain instances, based on current economic conditions, current market conditions, current margin amounts, an electronic trader may execute a trade with a larger or extreme amount of risk not only to the trader, but to the broker, trading firm, etc. In addition, a trader who has been making certain kinds of electronic trades with certain defined sets of trading parameters, may all of a sudden start making different kinds and amounts of electronic trades, thereby increasing the risk to the trader, broker, trading firm, etc. In such a circumstance, the broker, trading firm, etc. may be alerted in real-time and require the electronic trader take some additional steps to continue trading (e.g., add more money to margin accounts, remove other trading positions, etc.).

Near the far end of the trading risk spectrum, extreme risk can exist for all parties involved in an electronic trade. Around Chicago, Ill., such as trade is called on “O'hare Trade” since one major airport is the Chicago O'Hare airport. For an O'hare Trade, an electronic trader may risk everything they have, and typically more than everything they have, on one or more trades. Such extreme risk trades may actually be executed electronically while physically at the O'Hare airport. If the electronic trader successfully “wins” the extreme risk trade, everything is ok and the electronic trader may return home or immediately go on vacation to celebrate a big win.

However, it the electronic trader “loses” the extreme risk trade, the electronic trader may then actually board and airplane at O'hare airport and fly away and never return. For such a extreme risk trade that is lost, the broker, trading firm, etc. may be stuck absorbing the loss from the O'hare Trade since the electronic trader may never be found or not have enough total assets to cover the trade. The present invention is designed in part to alert a broker, trading firm, etc. of such an extreme high risk trade.

Returning to FIG. 7, at Step 92, a test is conducted to determine if the risk assessment exceeds one or more of the determined risk thresholds. The test is conducted periodically and continuously in real-time as trader's positions dynamically change and as market conditions dynamically change.

If the determined risk exceeds one or more of the determined risk thresholds, one or more different types of risk trading alerts are issued in real-time at Step 94. The one or more types of risk trading alerts are used to notify a trader, broker, trading firm office, trading firm, fund manager, trading exchanges, etc. that a trader has currently exceeded a risk management threshold. Such risk alerts can also be used to notify the trader of current risk associated with trading position.

In one embodiment of the present invention, generating any pre-risk trading alert of a pre-determined type (e.g., warning, emergency, etc.) automatically suspends trading by the electronic trader on one or more trading accounts.

In another embodiment, generation of any risk trading alerts of any kind may also temporarily or permanently alter or prohibit additional trades by a trader until market conditions change, the trader supplies more capital to an account used for trading, the trader supplies more capital to the trader's broker or other pre-determined risk conditions, etc.

In one embodiment, the one or more risk trading alerts are issued in real-time to and sent in real-time to broker servers 26 for which the electronic trader has the one or more electronic trading accounts. The broker may suspend or limit further trades for the trader. The trading alerts may also be sent in real-time to the one or more trading exchanges 20, 22, 24. The trading alerts may also be sent to target device 12, 14, 16 to alert a trader that he/she has exceeded a risk threshold for his/her electronic trading.

In one embodiment, Method 84 is practiced on the target devices 12, 14 16. In another embodiment, Method 84 is practiced on the server device 26. In another embodiment, it is practiced on both the target devices 12, 14, 16 and the server device 26.

In one embodiment, Method 84 is practiced using an event-driven architecture (EDA) and/or complex event processing (CEP). Risk assessment is completed using EDA and/or CEP.

EDA is a style of application architecture centered on asynchronous “push-based” communication. EDA is an architecture used for implementing “straight-through” multistage business processes that deliver goods, services and information with minimum delay such as electronic trading. Processes designed using EDA are also easier to modify than traditional applications.

CEP uses techniques for the detection of complex patterns of plural events, event correlation and abstraction, event hierarchies, and relationships between events such as causality, membership, and timing, and event-driven processes. CEP is used to extract the information value from multiple events including electronic trading. CEP systems find patterns in event data to detect opportunities and threats. Timely alerts are created and then pushed to the appropriate recipients, often using graphical Business Activity Monitoring (BAM) dashboards or other graphical displays. The result is faster and better operational decisions and more timely responses including those used for risk assessment in electronic trading. CEP technology is technology that it interacts with surrounding messaging infrastructure via adapters such as software development kits (SDK). CEP uses built-in integration with stored data (relational and otherwise) provides access to reference data repositories, historical data or other contextual systems.

In such an embodiment, the test at Step 92 may not be used since providing risk trading alerts is event based. In such an embodiment, risk trading alerts are generated dynamically and automatically as the risk assessments and risk thresholds are dynamically and automatically calculated.

### Analyzing Risk for Electronic Trading Using a Graphical User Interface

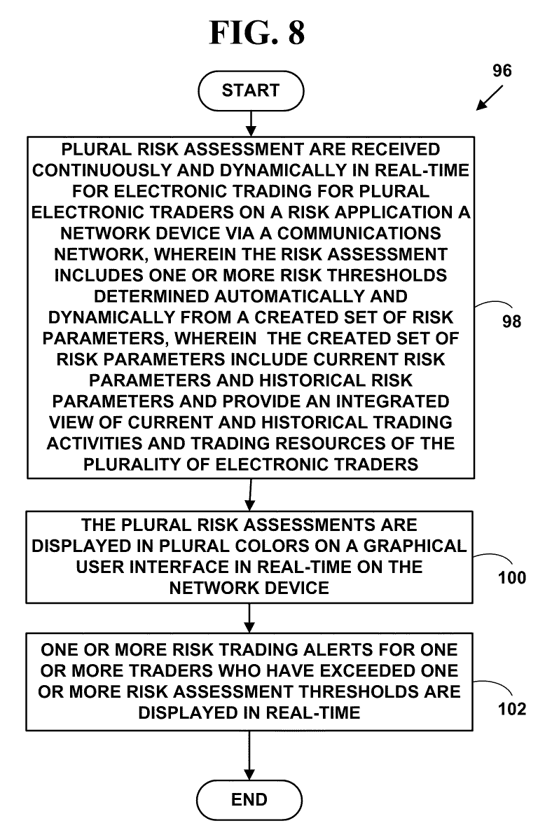

FIG. 8 is a flow diagram illustrating a Method 96 for analyzing risk for electronic trading. At Step 98, plural risk assessments for electronic trading are received on a risk application a network device via a communications network in real-time. The plural risk assessments include, but is not limited to, total account values, prior historical trading histories, current trading histories, etc. across all accounts with all brokers, etc. on all trading exchanges. The risk assessment also includes one or more risk thresholds determined automatically and dynamically from a created set of risk parameters. The set of risk parameters include current risk parameters and historical risk parameters and provide an integrated view of current and historical trading activities and trading resources of the electronic trader. At Step 100, the plural risk assessments are displayed in plural colors in one more windows on a graphical user interface in real-time. At Step 102, one or more risk trading alerts for a trader who have exceeded a pre-determined risk assessment threshold are displayed in real-time. The risk trading alerts are used to alter trading activity of traders who have exceeded the one or more created risk thresholds.

Method 96 is illustrated with one exemplary embodiment. However, the present invention is not limited to this embodiment and other embodiments can also be used to practice the invention.

At Step 98, plural risk assessments for electronic trading are received on the risk application 27 server device 26 via a communications network 18 in real-time. In one embodiment, the plural risk assessments are determined using Method 84. The plural risk assessments include, but is not limited to, total account values, prior historical trading histories, current trading histories, etc. across all accounts with all brokers, etc. on all trading exchanges. The risk assessment also includes one or more risk thresholds determined automatically and dynamically from a created set of risk parameters. The set of risk parameters include current risk parameters and historical risk parameters and provide an integrated view of current and historical trading activities and trading resources of the electronic trader. In another embodiment, plural risk assessments for electronic trading are also received on the risk application 27 on target network devices 12, 14, 16 via a communications network 18 in real-time. However, the present invention is not limited to such an embodiment and other methods can also be used to determine the plural risk assessments.

At Step 100, the plural risk assessments are displayed in plural colors on a graphical user interface in real-time. At Step 100, the plural risk assessments are displayed in plural colors on a graphical user interface in real-time. In one embodiment, the graphical user interface includes multiple windows.

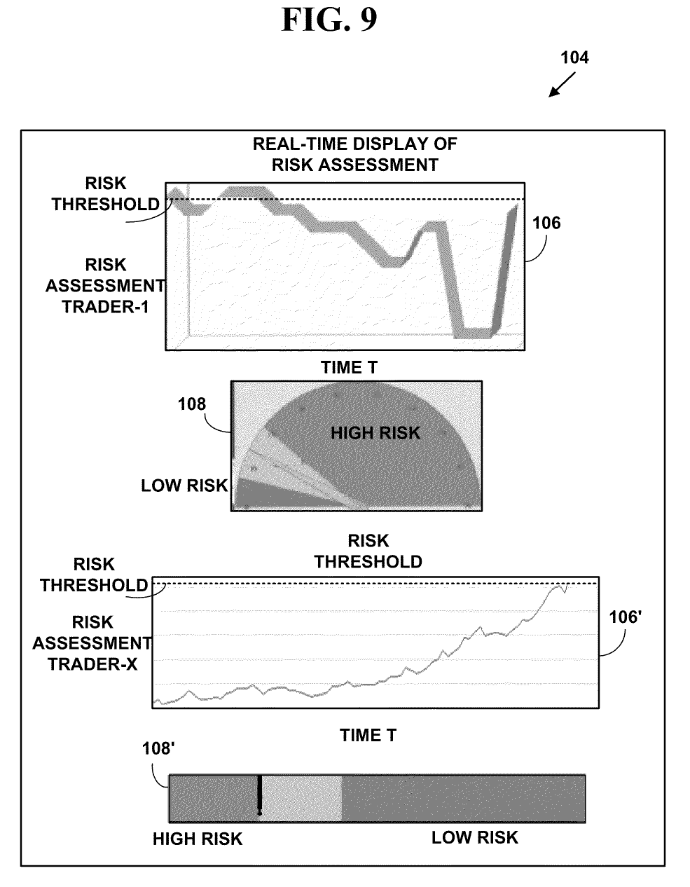

FIG. 9 illustrates one exemplary embodiment of the invention including a graphical user interface. However, the present invention is not limited to such an embodiment and other embodiments can also be used to practice the invention.

FIG. 9 is a block diagram 104 illustrating graphical display of risk assessment for electronic trading. The risk assessment for electronic traders executing electronic trades is displayed in multiple windows on a graphical user interface. The display is exemplary only and the present invention is not limited to such a display and types of displays can also be used to practice the invention. In addition, the risk assessment may also displayed in a non-graphical format using for example, electronic text, in one or more colors.

At Step 102, one or more risk trading alerts for trader who have exceeded a pre-determined risk assessment threshold are displayed in real-time. The risk trading alert is used to alter trading activity of traders who have exceeded the predetermined risk threshold.

In one embodiment the risk trading alerts are created and sent via Method 84. However, the present invention is not limited to such an embodiment and other methods can also be used to practice the invention.

In one embodiment, the risk trading alerts are used by entities who service electronic traders, such as brokers, firms, trading exchanges, etc. In one embodiment, the risk trading alerts are used to alter trading activity of traders who have exceeded the predetermined risk threshold. The risk trading alert is used to notify a trader, broker, trading exchanges, etc. that a trader has currently exceeded a risk management threshold. Such a risk trading alert notifies the trader of current risk associated with trading position. The risk trading alert may also temporarily or permanently alter or prohibit additional trades by a trader until market conditions change, the trader supplies more capital to an account used for trading, the trader supplies more capital to the trader's broker or other pre-determined risk conditions.

The graphical user interface includes various types of multi-color line graphs, bar graphs, 106, 106′ etc. all displaying risk assessments in various formats in multiple graphical user interface windows. In one embodiment, the graphical user interface may include a risk management graphical meter 108, 108′ wherein real-time risk assessments are displayed in green area when risk assessments are within less than some percentage of a pre-determined risk threshold (e.g., less than 10%, etc.), a yellow area when risk assessments are greater than some percentage of the pre-determined risk threshold (e.g., zero to 9%, etc.) and a red area when the pre-determined risk threshold has been exceeded and a risk trading alert has been issued.

In one embodiment, the risk assessments are displayed in plural colors on a graphical user interface in real-time using CEP and the Coral8 version of tools and Coral8 portal interface by Coral Corporation of Fremont, Calif. In another embodiment of the invention, the risk assessments are displayed in plural colors on a graphical user interface in real-time using the inventions described in co-pending U.S. patent applications by the current applicant, Ser. Nos. 11/180,330, 11/540,062 and 11/542,586, the contents of all of which are incorporated by reference.

However, the present invention is not limited to such embodiments and the risk assessments can be displayed in plural colors on the graphical user interface using other tools and via other methods.

The method and system allow risk associated with one or more trading accounts for a trader in multi-market electronic trading to be analyzed and managed in real-time. The method and system includes graphical display of risk assessments for plural traders.

It should be understood that the architecture, programs, processes, methods and It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. A method for analyzing risk for electronic trading, comprising:
collecting automatically and periodically in real-time electronic trading information for an electronic trader via a communications network via a risk application executing in a memory on a network device,
wherein the collected electronic trading information includes current and historical electronic trading execution information and current market trading information from a plurality of data streams from a plurality of electronic trading exchanges;
processing the electronic trading information with a pre-determined method to create a set of risk parameters, wherein the set of risk parameters include current risk parameters and historical risk parameters and provide an integrated view of current and historical trading activities and trading resources of the electronic trader across all electronic trading exchanges the electronic trader is trading on;
determining a risk assessment from the created set of risk parameters, wherein the risk assessment includes one or more risk thresholds determined automatically and dynamically from the created set of risk parameters;
conducting a test to determine if the risk assessment exceeds one or more determined risk thresholds,
and if so, issuing one or more risk trading alerts in real-time,
wherein the test is conducted periodically and continuously in real-time as the electronic trader's positions dynamically change and as market conditions dynamically change on the plurality of electronic trading exchanges,
wherein the one or more risk trading alerts are used to notify one or more brokers servicing the electronic trader and other designated parties that the electronic trader has currently exceed one or more risk thresholds.

2. A computer readable medium having stored therein a plurality of instructions in a memory for causing one or more processors to execute the steps of the method of claim 1.

3. The method of claim 1 wherein the set of risk parameters include maximum absolute position value by all accounts on all trading exchanges, absolute net position change by all accounts on all trading exchanges, total change in all positions in all accounts in all trading exchanges, total account value decline of greater than a pre-determined threshold, total trade volume and net profit and loss.

4. The method of claim 1 wherein the processing the electronic trading information with a pre-determined method includes producing real-time statistical studies of the collected electronic trading information including real-time statistical studies of historical electronic trading information and real-time statistical studies of current electronic trading information.

5. The method of claim 1 wherein the risk thresholds include risk thresholds created in real-time using current trading information and historical trading information.

6. The method of claim 1 wherein the determining steps includes:
dynamically and automatically determining in real-time a plurality of risk threshold values for a plurality of different current trading alerts using the created set of risk parameters, wherein the plurality of risk threshold values are dynamically and automatically determined using a pre-determined hierarchy; and
dynamically and automatically determining in real-time a plurality of risk threshold values for a plurality of different historical trading alerts using the created set of risk parameters, wherein the plurality of risk threshold values are dynamically and automatically determined using real-time statistical modeling of historical trading data.

7. The method of claim 6 wherein the pre-determined hierarchy includes a trading account hierarchy comprising a trading firm, a trading firm office and a trading account.

8. The method of claim 1 wherein the one or more risk trading alerts include a plurality of different notification, warning and emergency risk trading alerts.

9. The method of claim 1 wherein the integrated view of current and historical trading activities and trading resources of the electronic trader also includes electronic information about trades that were executed other than electronically.

10. The method of claim 1 wherein the risk assessment includes total account values, prior trading histories, current trading histories across all accounts with all brokers on all electronic trading exchanges the electronic trader is trading on.

11. The method of claim 1 wherein the one or more trading alerts are displayed graphically using one more different colors in one or more windows on a graphical user interface on the network device.

12. The method of claim 1 wherein the risk application uses an event-driven architecture (EDA) with complex event processing (CEP) to provide risk management dynamically and automatically in real-time.

14. The method of claim 1 wherein the network device is a target network device used by an electronic trader or a server network device.

15. A method for analyzing risk for electronic trading, comprising:
receiving continuously and dynamically in real-time a plurality of risk assessments for electronic trading for a plurality of electronic traders on a risk application a network device via a communications network, wherein the risk assessment includes one or more risk thresholds determined automatically and dynamically from a created set of risk parameters, wherein the created set of risk parameters include current risk parameters and historical risk parameters and provide an integrated view of current and historical trading activities and trading resources of the plurality of electronic traders;
displaying continuously and dynamically in real-time the plurality of risk assessments in a plurality colors in one more windows on a graphical user interface in on the network device; and
displaying continuously and dynamically in real-time one or more risk trading alerts for one or more electronic traders who have exceeded one or more pre-determined risk assessment thresholds, wherein the one or more risk trading alerts are used to alter trading activity of electronic traders who have exceeded one or more risk thresholds.

16. A computer readable medium having stored therein a plurality of instructions in a memory for causing one or more processors to execute the steps of the method of claim 15.

17. The method of claim 16 wherein the one or more risk thresholds determined automatically and dynamically from a created set of risk parameters includes:
dynamically and automatically determining in real-time a plurality of risk threshold values for a plurality of different current trading alerts using the created set of risk parameters, wherein the plurality of risk threshold values are dynamically and automatically determined using a pre-determined hierarchy; and
dynamically and automatically determining in real-time a plurality of risk threshold values for a plurality of different historical trading alerts using the created set of risk parameters, wherein the plurality of risk threshold values are dynamically and automatically determined using real-time statistical modeling of historical trading data.

18. The method of claim 15 wherein the one or more risk trading alerts include current risk trading alerts and historical risk trading alerts.

19. The method of claim 18 wherein the current risk trading alerts and the historical risk trading alerts each include a plurality of different notification, warning and emergency risk trading alerts.

20. A system for analyzing risk for electronic trading, comprising in combination:
means for collecting automatically and periodically in real-time electronic trading information for an electronic trader via a communications network via a risk application executing in a memory on a network device, wherein the collected electronic trading information includes, current and historical electronic trading execution information and current market trading information from a plurality of data streams from a plurality of electronic trading exchanges;
means for processing the electronic trading information with a pre-determined method to create a set of risk parameters, wherein the set of risk parameters include current risk parameters and historical risk parameters and provide an integrated view of current and historical trading activities and trading resources of the electronic trader across all electronic trading exchanges the electronic trader is trading on;
means for determining a risk assessment from the created set of risk parameters, wherein the risk assessment includes one or more risk thresholds determined automatically and dynamically from the created set of risk parameters, wherein the one or more risk thresholds include current trading risk thresholds and historical trading risk threshold, wherein the current trading risk thresholds are dynamically and automatically determined in real-time for a plurality of different current trading alerts using the created set of risk parameters, wherein the plurality of current trading risk threshold values are dynamically and automatically determined using a pre-determined risk hierarchy and wherein the historical trading risk thresholds are dynamically and automatically determined in real-time for a plurality of different historical trading alerts using the created set of risk parameters, wherein the plurality of threshold values are dynamically and automatically determined using real-time statistical modeling of historical trading data;
means for conducting a test to determine if the risk assessment exceeds one or more determined risk thresholds, and if so, issuing one or more risk trading alerts in real-time, wherein the test is conducted periodically and continuously in real-time as trader's positions dynamically change and as market conditions dynamically change, wherein the one or more risk trading alerts are used to notify one or more brokers servicing the electronic trader and other designated parties that the electronic trader has currently exceeded one or more risk thresholds; and
means for displaying continuously and dynamically in real-time one or more risk trading alerts for one or more electronic traders who have exceeded one or more pre-determined risk assessment thresholds, wherein the one or more risk trading alerts are used to alter trading activity of electronic traders who have exceeded one or more risk thresholds.
